(19) United States
(12) Patent Application Publication
(10) Pub. No.: US 2026/0171647 A1
(43) Pub. Date: Jun. 18, 2026

(54) TRANSPARENT ANTENNA APPARATUS FOR VEHICLE

(71) Applicants: Hyundai Motor Company, Seoul (KR); Kia Corporation, Seoul (KR); LG Electronics Inc., Seoul (KR)

(72) Inventors: Oh Yun KWON, Hwaseong-si (KR); Byoung Hyun Lee, Hwaseong-si (KR); Kang Jae Jung, Seoul (KR); Dong Jin Kim, Seoul (KR); Won Jeong Jeong, Seoul (KR); Ui Sheon Kim, Gunpo-si (KR); Byung Woon Jung, Seoul (KR); So Yeon Lee, Seoul (KR)

(21) Appl. No.: 19/249,717

(22) Filed: Jun. 25, 2025

(30) Foreign Application Priority Data
Dec. 18, 2024 (KR) 10-2024-0190028

(51) Int. Cl. H01Q 1/12; B60K 35/21; B60K 35/28; B60K 35/60

(52) U.S. Cl. CPC H01Q 1/1271; B60K 35/21; B60K 35/28; B60K 35/60; B60K 2360/164; B60K 2360/166; B60K 2360/785

(57) ABSTRACT

In an embodiment an antenna apparatus includes a windshield, an integration module including an SXM antenna, the integration module being attached to the windshield, a plurality of antennas disposed on a top of the windshield and an infotainment unit, wherein the infotainment unit, the integration module, and the plurality of antennas are arranged adjacent to each other and the windshield.

### CROSS-REFERENCE TO RELATED APPLICATIONS

This application claims the benefit of and priority to Korean Patent Application No. 10-2024-0190028, filed on Dec. 18, 2024, the entire disclosure(s) of which is hereby incorporated herein by reference in its entirety.

### TECHNICAL FIELD

The present disclosure relates to a transparent antenna apparatus for a vehicle

### BACKGROUND

The content described hereinbelow merely provides background information on the present disclosure and does not constitute the prior art.

As services provided through a vehicle diversify, various types of antennas are installed in a vehicle. There is a roof antenna which is usually mounted on a roof of the vehicle. The roof antenna is often made in a shape similar to a shark's fin, so it is also called a shark fin antenna.

FIG. 1 is a diagram showing a conventional antenna mounted on a vehicle.

Conventional vehicles may include a roof antenna 100.

The vehicle may further include a glass antenna 130 integrated with a heating element. The glass antenna 130 may be implemented in an area excluding an empty space 120 on the top of a glass 110 so as to operate a High Mount Stop Lamp (HMSL) and a built-in camera.

The glass antenna 130 is integrated with the heating element of the vehicle's glass 110 and is not easily recognizable as an antenna. Hence, the glass antenna 130 does not impair the appearance, thereby improving the overall design completeness of the vehicle.

On the other hand, the roof antenna 100 is an element protruding from the exterior of the vehicle, which disrupts the sense of unity in the vehicle design and is often requested for removal by users for aesthetic reasons. Further, an external antenna is problematic in that air resistance increases when the vehicle is driving, so the fuel efficiency of the vehicle is lowered and driving performance is deteriorated.

Recently, there is a trend to reduce the size of the roof antenna 100 or to remove the roof antenna 100. The reason is because the design of the vehicle's exterior can be improved and air resistance can also be reduced when the size of the roof antenna 100 protruding from the outside of the vehicle is reduced or the roof antenna 100 is removed. However, if the size of the roof antenna 100 is reduced or the roof antenna 100 is removed, there is a concern that a frequency band that the vehicle may receive may be reduced or a communication function may be degraded. For instance, if the roof antenna 100 is removed, another antenna will be needed to replace the roof antenna 100. For example, when the size of the roof antenna 100 is reduced, it is difficult to appropriately arrange a plurality of radiators in an internal space of the reduced roof antenna 100, and interference between the radiators occurs due to narrow spacing between the radiators, thereby causing deterioration in antenna performance.

In order to reduce the size of the roof antenna 100 or to eliminate the roof antenna 100, an antenna that can perform all or some of the functions of the roof antenna 100 is required.

A conventional CCS antenna or GNSS antenna is usually built in the roof antenna, such as the shark fin antenna to be placed on the top of a rear roof of the vehicle. Further, an infotainment unit 150 is placed inside a cockpit formed at the front of the vehicle and is connected to the CCS antenna or GNSS antenna using a coaxial cable. However, when a next-generation communication technology such as 5G is applied, there are limitations in external design due to the external protruding structure of the roof antenna, and it is difficult to increase the antenna size. In other words, this is problematic in that it is impossible to integrate the antenna for the next-generation communication technology such as 5G.

Further, the conventional CCS antenna or GNSS antenna has a structural problem in that a physical distance between the antenna and the infotainment unit 150 is very long. The longer the distance between the infotainment unit 150 and the antennas, the greater the loss of an RF line 140. In particular, since the loss rate of the RF line 140 tends to increase as the frequency increases, when a high frequency band communication technology such as 5G is applied, there is a concern that the performance of the entire vehicle communication system may deteriorate due to the high loss of the RF line 140.

### SUMMARY

Embodiments provide a communication system for a vehicle that reduces the loss of an RF line using a transparent antenna on a windshield of the vehicle.

Further embodiments improve the performance of a communication system of a vehicle through the shortest distance arrangement between a GNSS antenna and an integration module.

Embodiments are not limited to the above-mentioned embodiments, and other embodiments, which are not mentioned will be clearly understood by those skilled in the art from the following description.

According to an embodiment, a transparent antenna apparatus for a vehicle can improve the performance of a vehicle communication system by reducing the loss of an RF line by applying a transparent antenna to a windshield of the vehicle.

According to an embodiment, a transparent antenna apparatus for a vehicle can increase signal transmission efficiency through the shortest distance arrangement between a GNSS antenna and an integration module, thereby optimizing the performance of a vehicle communication system.

### BRIEF DESCRIPTION OF THE DRAWINGS

FIG. 1 is a diagram showing a conventional antenna structure for a vehicle;

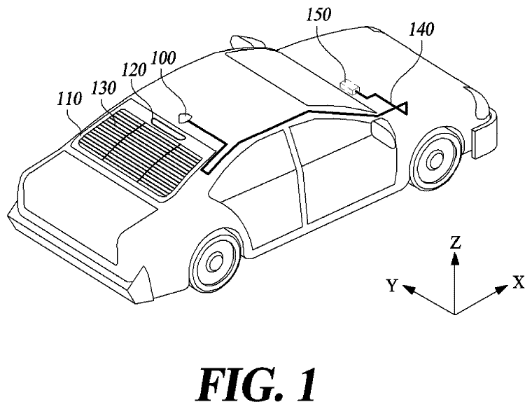

FIG. 2 is a diagram showing a plurality of antennas disposed on a windshield according to an embodiment of the present disclosure;

FIG. 3 is a diagram showing an integration module according to an embodiment of the present disclosure;

FIG. 4 is an exploded perspective view of the integration module according to an embodiment of the present disclosure; and

FIG. 5 is a circuit block diagram of the integration module according to an embodiment of the present disclosure.

### DETAILED DESCRIPTION OF ILLUSTRATIVE EMBODIMENTS

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

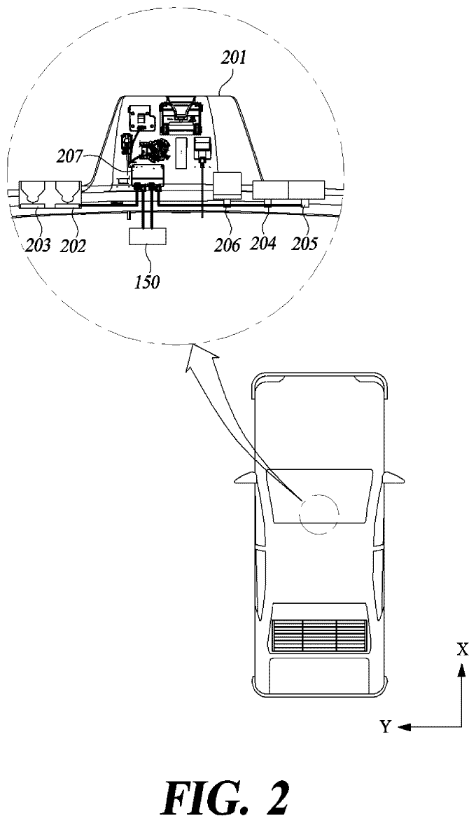

FIG. 2 is a diagram showing a plurality of antennas disposed on a windshield according to an embodiment of the present disclosure.

Referring to FIG. 2, a plurality of antennas 202, 203, 204, 205, and 206 according to an embodiment of the present disclosure include some or all of a Global Navigation Satellite System (GNSS) antenna 206, a first Cellular Communication System (CCS) antenna 202, a second CCS antenna 203, a third CCS antenna 204, and a fourth CCS antenna 205.

The plurality of antennas 202, 203, 204, 205, and 206 may be disposed adjacent to an integration module 207 that will be described below.

The plurality of antennas 202, 203, 204, 205, and 206 may be disposed at the top on a windshield 200 of the vehicle.

The plurality of antennas 202, 203, 204, 205, and 206 may be configured as a transparent antenna. The plurality of antennas 202, 203, 204, 205, and 206 according to the present disclosure may not be visually noticeable by using a transparent material, and may be manufactured using a transparent conductive material to perform the function of the antenna.

The plurality of antennas 202, 203, 204, 205, and 206 may be attached and fixed to the inner surface of the windshield 200.

An infotainment unit 150 according to the present disclosure may be placed anywhere in the front of the vehicle. Specifically, the infotainment unit 150 may be fixed to a cowl crossbar in an engine room of the vehicle using a bracket or the like.

The integration module 207 is installed on the inner side of the upper center of the vehicle windshield 200, and is firmly connected to the windshield 200 using a windshield integrated cover 201.

The plurality of CCS antennas 202, 203, 204, and 205 disposed on both edges of the windshield 200 receive data communication signals. The signals received from the plurality of CCS antennas 202, 203, 204 and 205 are transmitted to the integration module 207 through wiring and processed through a matching circuit and an amplifier within the integration module 207. The processed signals are transmitted to the infotainment unit 150 via a Fachkreis Automobil (FAKRA) connector.

The GNSS antenna 206 located at the upper center of the windshield 200 receives a satellite signal, and the received signal is amplified and filtered through a low noise amplifier (LNA) inside the integration module 207 and then transmitted to the infotainment unit 150.

An SiriusXM (SXM) patch antenna 307 is included in the integration module 207 according to the present disclosure. The SXM patch antenna 307 receives a satellite broadcasting (SDARS) signal, and the received signal is processed through the low noise amplifier (LNA) and a filter. The processed SXM signal is powered through a Bias Tee and transmitted to the infotainment unit 150. The SXM patch antenna 307 is applicable according to the vehicle model and user requirements, and provides a satellite broadcasting receiving function.

The integration module 207 is coupled to the windshield 200 using an adhesive member 306 or the like. For example, the adhesive member 306 may be composed of a film or an adhesive. The coupling structure of the integration module 207 may maintain a stable mounting state on the windshield 200 even when subjected to vibration and shock during vehicle operation, and may increase assembly efficiency.

The integration module 207 and the infotainment unit 150 are connected via the FAKRA connector.

The plurality of CCS antennas 202, 203, 204 and 205 and the GNSS antenna 206 installed on the windshield 200 are configured not to be exposed to the outside. This improves aerodynamic performance compared to a roof antenna and enhances the exterior design of the vehicle. Signals generated from the plurality of CCS antennas 202, 203, 204 and 205 and the GNSS antenna 206 are intensively processed by the integration module 207, and a wiring path between them is optimized to reduce signal interference and implement efficient signal transmission.

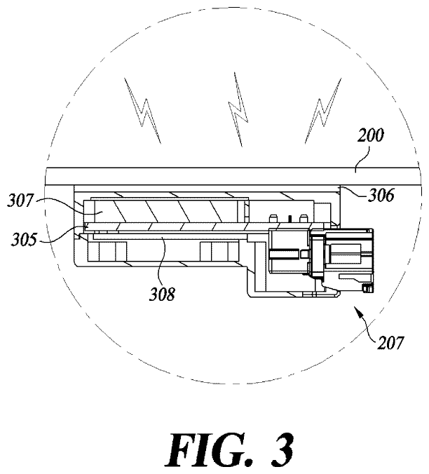

FIG. 3 is a diagram showing the integration module according to an embodiment of the present disclosure.

Referring to FIG. 3, the structure of the integration module according to the present disclosure is shown.

The integration module 207 is designed to stably provide communication and infotainment functions while removing an external antenna of the vehicle. The integration module 207 is coupled to the windshield 200 so that the antenna is not exposed to the outside. Thus, the integration module 207 can secure aerodynamic efficiency.

The integration module 207 includes main circuits and antennas within a cover 401 that is reduced in size. This improves assembly efficiency and maintains a stable mounting state even when subjected to vibration and external shock that may occur during vehicle operation.

The plurality of CCS antennas 202, 203, 204 and 205 and the GNSS antenna 206 are disposed on the windshield 200 and are connected to the integration module 207 to transmit a signal. The GNSS antenna 206 receives a satellite signal for position tracking and navigation services of the vehicle, and the plurality of CCS antennas 202, 203, 204, and 205 process a data communication signal.

The GNSS signal generated from the GNSS antenna 206 is amplified through a GNSS/SXM LNA circuit 308 inside the integration module 207, passes through the filter to remove an unnecessary frequency, and then is transmitted to a telematic control unit (TCU). CCS signals generated from the plurality of CCS antennas 202, 203, 204 and 205 are transmitted to the TCU through a PI network, which is a matching circuit, while reducing signal loss, and this design enables stable signal transmission. The SXM patch antenna 307 receives the satellite broadcasting (SDARS) signal, which is amplified through the satellite broadcasting low noise amplifier (LNA), passes through the filter, is processed through a Bias Tee circuit, and then is transmitted to the TCU. The SXM patch antenna 307 may be selectively applied according to the vehicle model and user requirements

The SXM patch antenna 307 is composed of a ceramic patch antenna. The SXM patch antenna 307 is integrated into a single module together with an antenna matching circuit 402, a GNSS/SXM LNA circuit 308, a power supply circuit, etc. within the integration module 207. This prevents signal interference caused by a metal material such as the vehicle body, and enables transmission and reception of electromagnetic waves through the glass of the windshield 200.

Further, the integration module 207 according to the present disclosure may change the antenna specification according to market requirements. For example, a dual design is possible that applies the SXM patch antenna 307 and the LNA circuit related to the SXM patch antenna 307 or excludes the corresponding configurations altogether.

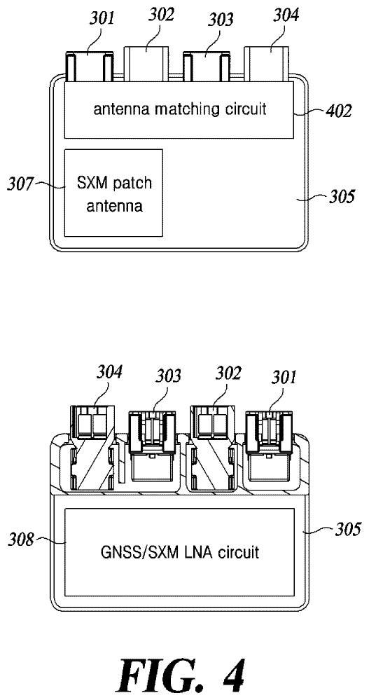

FIG. 4 is an exploded perspective view of the integration module according to an embodiment of the present disclosure.

FIG. 4 is a diagram showing the top surface of a PCB 305 in the integration module 207.

FIG. 4 is a diagram showing the back surface of the PCB 305 in the integration module 207.

Referring to FIG. 4, the overall size of the integration module 207 may be configured as, for example, 70 mm×56.5 mm.

The integration module 207 according to the present disclosure may be miniaturized to increase the utilization of space inside the vehicle. A plurality of RF connectors 301, 302, 303, and 304 may be disposed on one side of the integration module 207. The plurality of RF connectors 301, 302, 303 and 304 connect to various antennas and functions such as the CCS antenna, the GNSS antenna 206, the SXM patch antenna 307, and LTE.

The plurality of RF connectors 301, 302, 303, and 304 include a first RF connector 301, a second RF connector 302, a third RF connector 303, and a fourth RF connector 304.

The first RF connector 301 is connected to the third CCS antenna 204, the fourth CCS antenna 205, and the GNSS antenna 206. The third CCS antenna 204 and the fourth CCS antenna 205 are configured as transparent antennas disposed on the top of the vehicle windshield, receive a data communication signal and then transmit the signal to the integration module 207 through the first RF connector 301. The GNSS antenna 206 receives a satellite signal to provide position information of the vehicle. After the GNSS signal is transmitted through the first RF connector 301 into the integration module 207, it is amplified and filtered through the low noise amplifier (LNA) and the filter and then is transmitted to the infotainment unit 150.

The second RF connector 302 receives power related to the GNSS and SXM signals from the infotainment unit 150 to perform stable signal processing. The GNSS signal provides the position information of the vehicle, and the SXM signal includes a signal for satellite radio broadcasting (SDARS). The SXM patch antenna 307 transmits the signal through the second RF connector 302 to the integration module, and transmits the signal to the infotainment unit 150 after the signal is amplified and filtered internally.

The third RF connector 303 is connected to a Data Connectivity Unit (DCU) of the infotainment unit 150 to transmit or receive LTE 1, LTE 2, LTE 3, and LTE 4 signals. Each LTE signal supports the telematics service of the vehicle and is linked with an external vehicle network through the DCU to provide a wireless communication function. The LTE signals are transmitted to the integration module through the third RF connector 303 and then are processed in the DCU.

The fourth RF connector 304 is connected to the first CCS antenna 202 and the second CCS antenna 203. The first CCS antenna 202 and the second CCS antenna 203 receive data communication signals and transmit them to the integration module through the fourth RF connector 304. The transmitted signal is processed through the matching circuit and the amplifier inside the integration module and then is transmitted to the infotainment unit 150.

The SXM patch antenna 307 according to the present disclosure is selectively applied when the satellite broadcasting receiving function is required, and is configured to integrate the filter and the low noise amplifier (LNA) together with the GNSS antenna 206 to improve signal quality.

The GNSS/SXM LNA circuit 308 serving to amplify the signals of the GNSS antenna 206 and the SXM patch antenna 307 is located on the bottom of the PCB 305 of the integration module 207 according to the present disclosure. The GNSS/SXM LNA circuit 308 processes the signal together with the filter and has efficient power supply to contribute to reducing signal loss. The arrangement of the plurality of RF connectors 301, 302, 303, and 304 may be designed to enhance antenna-to-module and module-to-TCU connectivity while minimizing signal interference.

A main circuit size at the bottom of the integration module 207 may be configured as, for example, 65.6 mm×43 mm. The integration module 207 is configured to improve assembly efficiency by integrating the power feed connector and matching circuit of the plurality of CCS antennas 202, 203, 204, and 205 and the GNSS antenna 206, and to optimize antenna wiring design, thereby reducing signal loss.

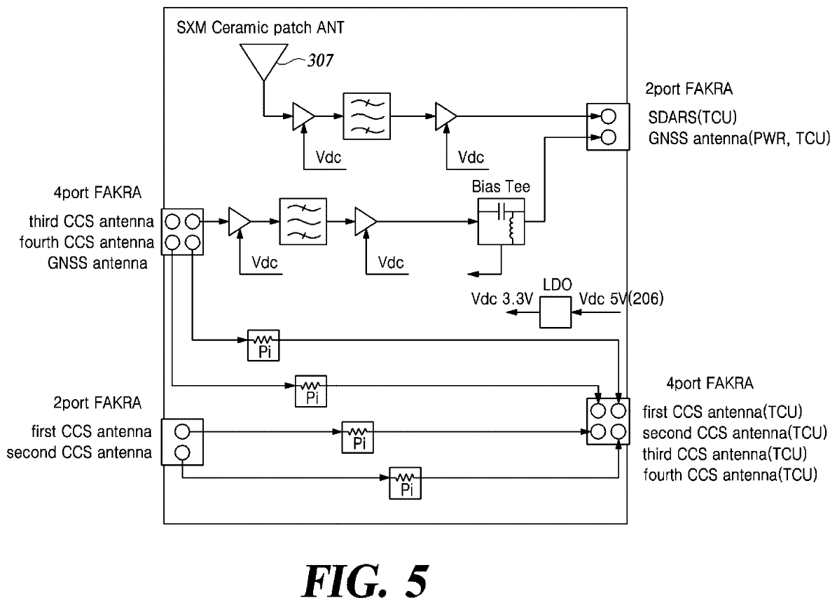

FIG. 5 is a circuit block diagram of the integration module according to an embodiment of the present disclosure.

Referring to FIG. 5, the main circuit of the integration module according to the present disclosure integrates and processes signals from the SXM patch antenna 307, the GNSS antenna 206, and the plurality of CCS antennas 202, 203, 204, and 205, and transmits the signals to the Telematics Control Unit (TCU).

The integration module 207 significantly improves assembly efficiency by integrating previously distributed antenna feed connectors into a single module. The integration module 207 includes a filter and LNA of a satellite receiving antenna that are difficult to implement on a transparent electrode, and integrates the SXM patch antenna. The power feed connectors of the plurality of CCS antennas 202, 203, 204, and 205 and the GNSS antenna 206 are integrated with each antenna matching circuit 402, the GNSS/SXM LNA circuit 308, and the filter to reduce signal loss that may occur in the RF line and to implement stable signal transmission.

The SXM patch antenna 307 receives the satellite broadcasting (SDARS) signal, and the signal is amplified through the low noise amplifier (LNA) and then passes through the filter to remove an unnecessary frequency. The signal from which the unnecessary frequency is removed receives power through the Bias Tee circuit, and then is transmitted through the 2-port FAKRA connector to the TCU.

The signal received from the GNSS antenna 206 is amplified through the GNSS/SXM LNA circuit 308, passes through the filter, and then is transmitted to the TCU. During this process, the GNSS circuit receives a stable power supply of 3.3V through a Low Dropout Regulator (LDO).

The plurality of CCS antennas 202, 203, 204, and 205 process four antenna signals of CCS1, CCS2, CCS3, and CCS4, and each signal is transmitted to the TCU while reducing signal loss through a PI network (matching circuit). In an example, the four antenna signals of CCS1, CCS2, CCS3, and CCS4 and the signal of the GNSS antenna 206 are connected through 4-port and 2-port FAKRA connectors to the TCU, and the arrangement of each connector is designed considering module assemblability. The GNSS/SXM LNA circuit 308 is coupled to each power supply line to implement stable signal processing.

The Bias Tee according to the present disclosure serves to comprehensively process the power supply of the SXM and GNSS circuits, and each circuit implements stable operation. The GNSS circuit receives power through the 5V LDO and transmits the signal to the TCU. The PI network of the circuit block diagram can optimize the matching of each antenna signal, thereby reducing signal loss and increasing transmission efficiency.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. An antenna apparatus comprising:
a windshield;
an integration module comprising an SiriusXM (SXM) antenna, the integration module being attached to the windshield;
a plurality of antennas disposed on a top of the windshield; and
an infotainment unit,
wherein the integration module and the plurality of antennas are arranged adjacent to each other and the windshield.

2. The antenna apparatus of claim 1, wherein the integration module is attached and fixed to an inner surface of the windshield with an adhesive member.

3. The antenna apparatus of claim 1, wherein the infotainment unit comprises:
a user interface module comprising a display and multimedia and navigation functions; and
a connection module comprising an RF receiver and a communication modem for data communication between the plurality of antennas and an external network.

4. The antenna apparatus of claim 1, wherein the infotainment unit is positioned adjacent to the integration module at a front of a vehicle.

5. The antenna apparatus of claim 1, wherein the plurality of antennas are arranged in an upper area of the windshield and adjacent to the integration module.

6. The antenna apparatus of claim 5, wherein the plurality of antennas comprise at least one Cellular Communication System (CCS) antenna and a Global Navigation Satellite System (GNSS) antenna.

7. The antenna apparatus of claim 6, wherein the at least one CCS antennas is arranged symmetrically with respect to the integration module.

8. The antenna apparatus of claim 6, wherein the GNSS antenna is arranged adjacent to the integration module and between at least two CCS antennas.

9. The antenna apparatus of claim 1, wherein the SXM antenna comprises a high dielectric constant ceramic material and is mounted on a PCB of the integration module.

10. The antenna apparatus of claim 1, wherein the plurality of antennas are a plurality of transparent antennas.

11. A vehicle comprising:
a roof;
a windshield;
an integration module including an SXM antenna attached to the windshield;
a plurality of transparent antennas located at an upper center of the windshield towards the roof; and
an infotainment unit,
wherein the integration module and the plurality of transparent antennas are arranged adjacent to each other and to the windshield, and
wherein the integration module is connected to the plurality of transparent antennas and the infotainment unit.

12. The vehicle of claim 11, wherein the plurality of transparent antennas comprises at least one Cellular Communication System (CCS) antenna and a Global Navigation Satellite System (GNSS) antenna.

13. The vehicle of claim 12, wherein the at least one CCS antenna are arranged symmetrically with respect to the integration module.

14. The vehicle of claim 13, wherein the GNSS antenna is arranged adjacent to the integration module and between at least two CCS antennas.

15. The vehicle of claim 11, wherein the integration module is attached to an inner surface of the windshield.

16. The vehicle of claim 11, wherein the infotainment unit is connected to the integration module via at least one Fachkreis Automobil (FAKRA) connector.

17. The vehicle of claim 11, wherein the infotainment unit comprises:
a user interface module configured to display multimedia and navigation functions; and—a connection module including an RF receiver and a communication modem for data communication between the plurality of transparent antennas and an external network.

18. The vehicle of claim 11, wherein the SXM antenna comprises a high dielectric constant ceramic material and is mounted on a PCB of the integration module.

19. The vehicle of claim 11, wherein the integration module comprises a plurality of RF connectors configured to connect to the plurality of transparent antennas, and wherein the plurality of RF connectors consists of a first RF connector, a second RF connector, a third RF connector, and a fourth RF connector.

20. The vehicle of claim 19, wherein the first RF connector is connected to a first CCS antenna, a second CCS antenna, and a GNSS antenna, wherein the second RF connector is configured to receive power related to GNSS and SXM signals from the infotainment unit, wherein the third RF connector is connected to a data connectivity unit (DCU) of the infotainment unit and configured to transmit or receive LTE 1, LTE 2, LTE 3, and LTE 4 signals, and wherein the fourth RF connector is connected to a third CCS antenna and a fourth CCS antenna.
